(19) United States
(12) Patent Application Publication
(10) Pub. No.: US 2024/0160661 A1
(43) Pub. Date: May 16, 2024

(54) IMAGE RETRIEVING DEVICE AND IMAGE RETRIEVING METHOD

(71) Applicant: Mitsubishi Electric Corporation, Tokyo (JP)

(72) Inventors: Takayuki SEMITSU, Tokyo (JP); Mitsuki NAKAMURA, Tokyo (JP); Shotaro ISHIGAMI, Tokyo (JP); Teng-Yok LEE, Tokyo (JP); Yoshimi MORIYA, Tokyo (JP)

(73) Assignee: Mitsubishi Electric Corporation, Tokyo (JP)

(21) Appl. No.: 18/419,849

(22) Filed: Jan. 23, 2024

Related U.S. Application Data
(63) Continuation of application No. PCT/JP2021/031270, filed on Aug. 26, 2021.

(51) Int. Cl. G06F 16/583; G06F 16/532; G06F 16/55; G06V 10/74

(52) U.S. Cl. CPC G06F 16/583; G06F 16/532; G06F 16/55; G06V 10/761

(57) ABSTRACT

An image retrieving device includes processing circuitry configured to give a query image that is an image to be identified to a first learning model, acquire a feature vector of the query image from the first learning model, give each of a plurality of gallery images to the first learning model, and acquire a feature vector of each of the gallery images from the first learning model; give the query image to a second learning model, and acquire, from the second learning model, reliability of retrieval when K gallery images having a relatively high possibility of including a subject included in the query image are retrieved from the plurality of the gallery images; retrieve the K gallery images from the plurality of the gallery images; and specify the reliability of retrieval.

### CROSS REFERENCE TO RELATED APPLICATIONS

This application is a Continuation of PCT International Application No. PCT/JP2021/031270 filed on Aug. 26, 2021, which is hereby expressly incorporated by reference into the present application.

### TECHNICAL FIELD

The present disclosure relates to an image retrieving device and an image retrieving method.

### BACKGROUND ART

Conventionally, there is an image retrieving device (hereinafter referred to as a “conventional image retrieving device”) including an image retrieving unit that retrieves a gallery image including a subject included in an image to be identified (hereinafter referred to as a “query image”) from among a plurality of images to be identified (hereinafter referred to as “gallery images”).

Meanwhile, as an image retrieval technique for retrieving an image similar to an image to be identified, Patent Literature 1 discloses a technique in which an image retrieving unit gives an image to be identified to a classifier and acquires an image similar to the image to be identified from the classifier.

### CITATION LIST

### Patent Literature

Patent Literature 1: Japanese Patent Laid-Open Publication No. 2020-119508

### SUMMARY OF INVENTION

### Technical Problem

In the conventional image retrieving device, there is a problem that the reliability of retrieval by the image retrieving unit cannot be checked. Therefore, it is not known whether the subject included in the gallery image retrieved by the image retrieving unit is the same as the subject included in the query image with a high probability, or is not the same with a high probability and there is a sufficient possibility of another subject.

Even with the image retrieval technique disclosed in Patent Literature 1, the reliability of retrieval by the image retrieving unit cannot be checked. Therefore, even if the image retrieval technique can be applied to a conventional image retrieving device, the above problem cannot be solved.

The present disclosure has been made to solve the above problems, and an object of the present disclosure is to obtain an image retrieving device and an image retrieving method capable of confirming the reliability of retrieval by an image retrieving unit.

### Solution to Problem

An image retrieving device according to the present disclosure includes: processing circuitry configured to give a query image that is an image to be identified to a first learning model, acquire a feature vector of the query image from the first learning model, give each of a plurality of gallery images that are the images to be identified to the first learning model, and acquire a feature vector of each of the gallery images from the first learning model; give a query image to a second learning model, and acquire, from the second learning model, reliability of retrieval when K (K is an integer equal to or more than one) gallery images having a relatively high possibility of including a subject included in the query image are retrieved from the plurality of gallery images; retrieve K gallery images from the plurality of gallery images on the basis of the feature vector of the acquired query image and the feature vector of each of the gallery images; and specify the reliability of retrieval from the acquired reliability.

### Advantageous Effects of Invention

According to the present disclosure, it is possible to check the reliability of retrieval by the image retrieving unit.

### BRIEF DESCRIPTION OF DRAWINGS

FIG. 1 is a configuration diagram illustrating an image retrieving device according to a first embodiment.

FIG. 2 is a hardware configuration diagram illustrating hardware of the image retrieving device according to the first embodiment.

FIG. 3 is a hardware configuration diagram of a computer in a case where the image retrieving device is implemented by software, firmware, or the like.

FIG. 4 is a configuration diagram illustrating a learning device that generates each of a first learning model 5 and a second learning model 6 used by the image retrieving device illustrated in FIG. 1.

FIG. 5 is a hardware configuration diagram illustrating hardware of the learning device illustrated in FIG. 4.

FIG. 6 is a hardware configuration diagram of a computer in a case where the learning device is implemented by software, firmware, or the like.

FIG. 7A is an explanatory diagram illustrating an example of a learning image group GG including M learning images gg₁ to ggₘ, and FIG. 7B is an explanatory diagram illustrating an example of a query image q and a gallery image group G.

FIG. 8 is an explanatory diagram illustrating a position of a learning image ggₘ (m=1, . . . , M) in an image feature space.

FIG. 9 is a flowchart illustrating an image retrieving method which is a processing procedure performed by the image retrieving device illustrated in FIG. 1.

FIG. 10 is an explanatory diagram illustrating K gallery images g₁′ to g_{K}′ having a relatively high possibility of including a subject included in a query image q.

FIG. 11 is an explanatory diagram illustrating a distance learning method called Triplet Loss.

FIG. 12 is a configuration diagram illustrating an image retrieving device according to a second embodiment.

FIG. 13 is a hardware configuration diagram illustrating hardware of the image retrieving device according to the second embodiment.

FIG. 14 is a configuration diagram illustrating a learning device that generates each of a first learning model 5 and a second learning model 63 used by the image retrieving device illustrated in FIG. 12.

FIG. 15 is a hardware configuration diagram illustrating hardware of the learning device illustrated in FIG. 14.

FIG. 16 is a configuration diagram illustrating an image retrieving device according to a third embodiment.

FIG. 17 is a hardware configuration diagram illustrating hardware of the image retrieving device according to the third embodiment.

FIG. 18 is a configuration diagram illustrating a learning device that generates each of a first learning model 5 and a second learning model 66 used by the image retrieving device illustrated in FIG. 16.

FIG. 19 is a hardware configuration diagram illustrating hardware of the learning device illustrated in FIG. 18.

FIG. 20 is an explanatory diagram illustrating a frequency distribution of gallery images including a subject included in a query image and a frequency distribution of the gallery image not including the subject included in the query image.

### DESCRIPTION OF EMBODIMENTS

Hereinafter, in order to explain the present disclosure in more detail, a mode for carrying out the present disclosure will be described based on the accompanying drawings.

### First Embodiment

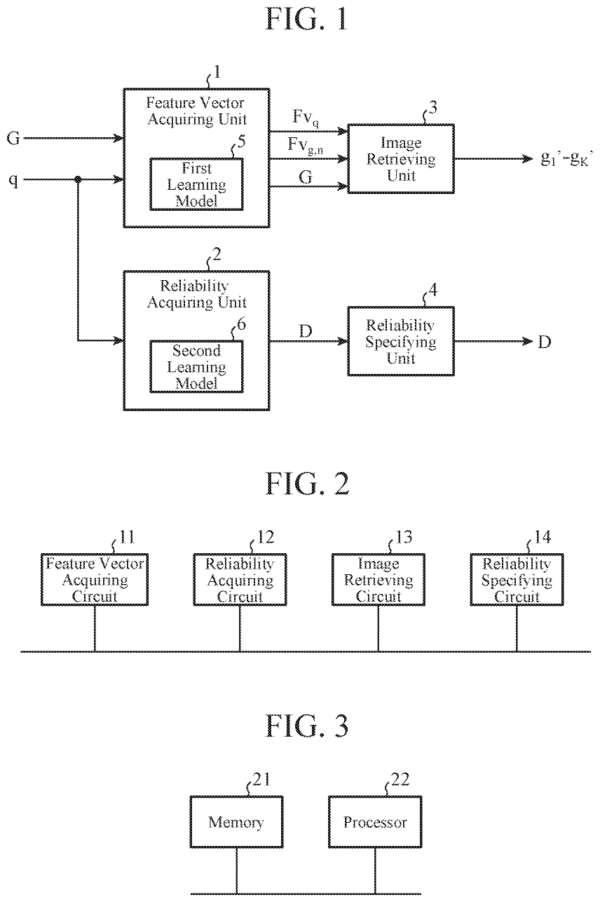

FIG. 1 is a configuration diagram illustrating an image retrieving device according to a first embodiment.

FIG. 2 is a hardware configuration diagram illustrating hardware of the image retrieving device according to the first embodiment.

The image retrieving device illustrated in FIG. 1 includes a feature vector acquiring unit 1, a reliability acquiring unit 2, an image retrieving unit 3 and a reliability specifying unit 4.

The feature vector acquiring unit 1 is implemented by, for example, a feature vector acquiring circuit 11 illustrated in FIG. 2.

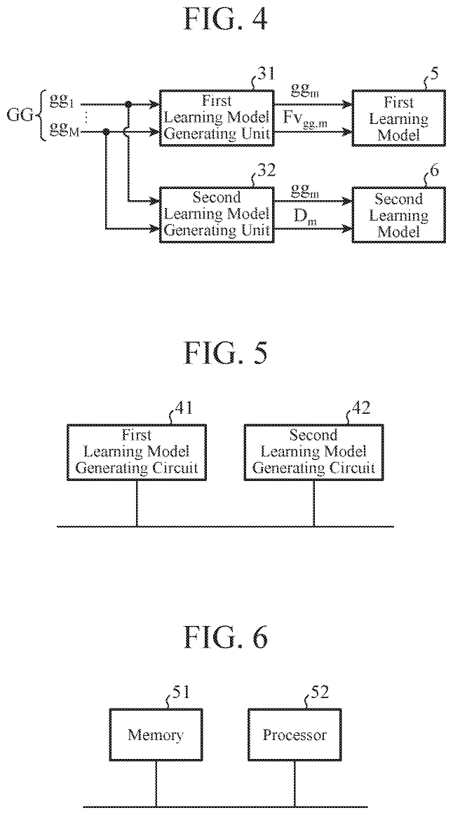

The feature vector acquiring unit 1 includes a first learning model 5. The first learning model 5 is generated by a learning device illustrated in FIG. 4.

The feature vector acquiring unit 1 acquires a query image q that is an image to be identified, and acquires a gallery image group G including N gallery images g₁ to g_{N} that are images to be identified. N is an integer equal to or more than one.

The feature vector acquiring unit 1 gives the query image q to the first learning model 5 and acquires the feature vector Fv_{q} of the query image q from the first learning model 5.

Moreover, the feature vector acquiring unit 1 gives the gallery image gₙ (n=1, . . . , N) to the first learning model 5 and acquires the feature vector Fv_{g,n} of the gallery image gₙ from the first learning model 5.

Each of the feature vector Fv_{q} and the feature vector Fv_{g,n}, indicates the position in an image feature space. If the image feature space is a two-dimensional feature space, it is conceivable that the horizontal axis of the feature space indicates, for example, the distance between the left eye and the right eye of a human who is a subject, and the vertical axis of the feature space indicates, for example, the distance from the outer corner of the eye to the nose.

The image feature space is not limited to a two-dimensional feature space and may be, for example, a three-dimensional feature space.

The feature vector acquiring unit 1 outputs, to the image retrieving unit 3, each of the gallery image group G, the feature vector Fv_{q} of the query image q, and the feature vector Fv_{g,n} of the gallery image gₙ.

The reliability acquiring unit 2 is implemented by, for example, a reliability acquiring circuit 12 illustrated in FIG. 2.

The reliability acquiring unit 2 includes a second learning model 6. The second learning model 6 is generated by a learning device illustrated in FIG. 4.

The reliability acquiring unit 2 acquires the query image q.

The reliability acquiring unit 2 gives the query image q to the second learning model 6 and acquires the retrieval reliability D when K gallery images g₁′ to g_{K}′ having a relatively high possibility of including the subject included in the query image q among the N gallery images g₁ to g_{N} from the second learning model 6. K is an integer equal to or more than one and equal to or less than N.

The reliability acquiring unit 2 outputs the acquired reliability D to the reliability specifying unit 4.

The image retrieving unit 3 is implemented by, for example, an image retrieving circuit 13 illustrated in FIG. 2.

The image retrieving unit 3 acquires each of the gallery image group G, the feature vector Fv_{q} of the query image q, and the feature vector Fv_{g,n} of the gallery image gₙ (n=1, . . . , N).

On the basis of the feature vector Fv_{q} of the query image q and the feature vector Fv_{g,n} of the gallery image gₙ, the image retrieving unit 3 retrieves K gallery images g₁′ to g_{K}′ having a relatively high possibility of including the subject included in the query image q from among the N gallery images g₁ to g_{N}.

The image retrieving unit 3 outputs the K gallery images g₁′ to g_{K}′ to the outside as image retrieval results, thereby causing a display or the like to display the K gallery images g₁′ to g_{K}′, for example.

The reliability specifying unit 4 is implemented by, for example, a reliability specifying circuit 14 illustrated in FIG. 2.

The reliability specifying unit 4 acquires the reliability D from the reliability acquiring unit 2.

The reliability specifying unit 4 specifies the reliability of the retrieval by the image retrieving unit 3 from the reliability D acquired by the reliability acquiring unit 2.

In the image retrieving device illustrated in FIG. 1, the reliability specifying unit 4 outputs the reliability D acquired by the reliability acquiring unit 2 to the outside as the reliability of the retrieval by the image retrieving unit 3.

The reliability specifying unit 4 outputs the reliability D of the retrieval by the image retrieving unit 3 to the outside, thereby causing a display or the like to display the reliability D of the retrieval by the image retrieving unit 3, for example.

In the image retrieving device illustrated in FIG. 1, the feature vector acquiring unit 1 includes a first learning model 5, and the reliability acquiring unit 2 includes a second learning model 6. However, this is merely an example, and the storage device (not illustrated) may include both the first learning model 5 and the second learning model 6. In a case where the storage device includes the first learning model 5, the feature vector acquiring unit 1 may acquire each of the feature vector Fv_{q} of the query image q and the feature vector Fv_{g,n} of the gallery image gₙ from the first learning model 5 included in the storage device. In a case where the storage device includes the second learning model 6, the reliability acquiring unit 2 may acquire the reliability D of the retrieval from the second learning model 6 included in the storage device.

In FIG. 1, it is assumed that each of the feature vector acquiring unit 1, the reliability acquiring unit 2, the image retrieving unit 3, and the reliability specifying unit 4, which are components of the image retrieving device, is implemented by dedicated hardware as illustrated in FIG. 2. That is, it is assumed that the image retrieving device is implemented by the feature vector acquiring circuit 11, the reliability acquiring circuit 12, the image retrieving circuit 13 and the reliability specifying circuit 14.

Each of the feature vector acquiring circuit 11, the reliability acquiring circuit 12, the image retrieving circuit 13 and the reliability specifying circuit 14 corresponds to, for example, a single circuit, a composite circuit, a programmed processor, a parallel-programmed processor, an application specific integrated circuit (ASIC), a field-programmable gate array (FPGA), or a combination thereof.

The components of the image retrieving device are not limited to those implemented by dedicated hardware, and the image retrieving device may be implemented by software, firmware, or a combination of software and firmware.

The software or firmware is stored in a memory of a computer as a program. The computer means hardware that executes a program and corresponds to, for example, a central processing unit (CPU), a central processing device, a processing device, an arithmetic device, a microprocessor, a microcomputer, a processor or a digital signal processor (DSP).

FIG. 3 is a hardware configuration diagram of a computer in a case where the image retrieving device is implemented by software, firmware, or the like.

In a case where the image retrieving device is implemented by software, firmware, or the like, a program for causing a computer to execute each processing procedure performed in the feature vector acquiring unit 1, the reliability acquiring unit 2, the image retrieving unit 3, and the reliability specifying unit 4 is stored in a memory 21. Then, a processor 22 of the computer executes the program stored in the memory 21.

Furthermore, FIG. 2 illustrates an example in which each of the components of the image retrieving device is implemented by dedicated hardware, and FIG. 3 illustrates an example in which the image retrieving device is implemented by software, firmware, or the like. However, these are merely examples, and some components in the image retrieving device may be implemented by dedicated hardware, and the remaining components may be implemented by software, firmware, or the like.

FIG. 4 is a configuration diagram illustrating a learning device that generates each of the first learning model 5 and the second learning model 6 used by the image retrieving device illustrated in FIG. 1.

FIG. 5 is a hardware configuration diagram illustrating hardware of the learning device illustrated in FIG. 4.

The learning device illustrated in FIG. 4 includes a first learning model generating unit 31 and a second learning model generating unit 32.

The first learning model generating unit 31 is implemented by, for example, a first learning model generating circuit 41 illustrated in FIG. 5.

The first learning model generating unit 31 acquires a learning image group GG including learning images gg₁ to gg_{M}, which are M images for learning. M is an integer equal to or more than K. Identification information idₘ indicating a subject included in the learning image ggₘ is added to the learning image ggₘ.

The first learning model generating unit 31 extracts a feature vector Fv_{gg,m} of the learning image ggₘ (m=1, . . . , M).

The first learning model generating unit 31 generates the first learning model 5 by using the M learning images gg₁ to gg_{M} and the M feature vectors Fv_{gg,1} to Fv_{gg,M}.

That is, the first learning model generating unit 31 gives the learning image ggₘ (m=1, . . . , M) to the first learning model 5 and gives the feature vector Fv_{gg,m} (m=1, . . . , M) to the first learning model 5 as teacher data, thereby causing the first learning model 5 to learn the feature vector Fv_{gg m} of the learning image ggₘ.

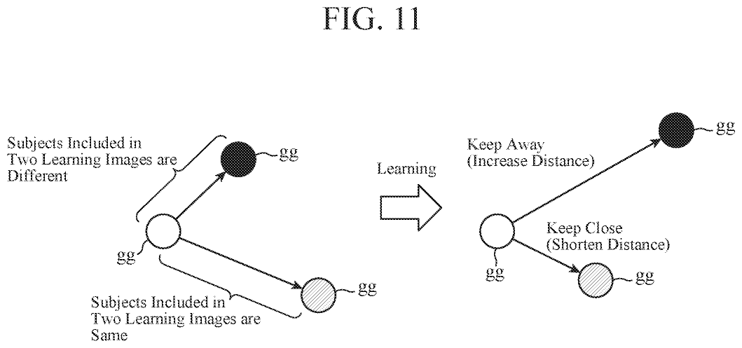

When causing the first learning model 5 to learn the feature vector Fv_{gg,m} of the learning image ggₘ, the first learning model generating unit 31 causes the first learning model 5 to learn the position in the image feature space indicated by the feature vector Fv_{gg,m} by using, for example, a distance learning method called Triplet Loss as illustrated in FIG. 11. That is, the first learning model generating unit 31 causes the feature vectors Fv_{gg,m} of the learning images ggₘ to be learned in such a way that the positions of the learning images having the same subject indicated by the identification information idₘ among the M learning images gg₁ to gg_{M} keep close to each other. The first learning model generating unit 31 causes the feature vectors Fv_{gg,m} of the learning images ggₘ to be learned in such a way that the positions of the learning images having the different subjects indicated by the identification information idₘ among the M learning images gg₁ to gg_{M} keep away from each other.

The first learning model generating unit 31 provides the learned first learning model 5 to the feature vector acquiring unit 1 of the image retrieving device illustrated in FIG. 1.

FIG. 11 is an explanatory diagram illustrating a distance learning method called Triplet Loss. The distance learning method illustrated in FIG. 11 is a method of causing the feature vectors Fv_{gg,m} of the learning images ggₘ to be learned in such a way as to keep close to each other for the positions of the learning images in which the included subjects are the same and causing the feature vectors Fv_{gg,m} of the learning images ggₘ to be learned in such a way as to keep away from each other for the positions of the learning images in which the included subjects are different.

The second learning model generating unit 32 is implemented by, for example, a second learning model generating circuit 42 illustrated in FIG. 5.

The second learning model generating unit 32 acquires a learning image group GG including learning images gg₁ to gg_{M}, which are M learning images.

The second learning model generating unit 32 calculates the reliability Dₘ on the basis of the identification information idₘ added to the learning image ggₘ (m=1, . . . , M).

For example, if the second learning model generating unit 32 calculates the reliability D₁, the second learning model generating unit 32 calculates a ratio indicating the same subject as the identification information id₁ added to the learning image gg₁ among the identification information id₁ to id_{M} added to the learning images gg₁ to gg_{M}.

For example, if the second learning model generating unit 32 calculates the reliability D₂, the second learning model generating unit 32 calculates a ratio indicating the same subject as the identification information id₂ added to the learning image gg₂ among the identification information id₁ to id_{M} added to the learning images gg₁ to gg_{M}.

The second learning model generating unit 32 generates the second learning model 6 by using the M learning images gg₁ to gg_{M} and the M reliabilities D₁ to D_{M}.

That is, the second learning model generating unit 32 causes the second learning model 6 to learn the reliability Dₘ by giving the learning image ggₘ (m=1, . . . , M) to the second learning model 6 and giving the reliability Dₘ to the second learning model 6 as teacher data.

The second learning model generating unit 32 gives the learned second learning model 6 to the reliability acquiring unit 2 of the image retrieving device illustrated in FIG. 1.

In FIG. 4, it is assumed that each of the first learning model generating unit 31 and the second learning model generating unit 32, which are components of the learning device, is implemented by dedicated hardware as illustrated in FIG. 5. That is, it is assumed that the learning device is implemented by the first learning model generating circuit 41 and the second learning model generating circuit 42.

Each of the first learning model generating circuit 41 and the second learning model generating circuit 42 corresponds to, for example, a single circuit, a composite circuit, a programmed processor, a parallel-programmed processor, ASIC, FPGA, or a combination thereof.

The components of the learning device are not limited to those implemented by dedicated hardware, and the learning device may be implemented by software, firmware, or a combination of software and firmware.

FIG. 6 is a hardware configuration diagram of a computer in a case where the learning device is implemented by software, firmware, or the like.

In a case where the learning device is implemented by software, firmware, or the like, a program for causing a computer to execute each processing procedure performed in the first learning model generating unit 31 and the second learning model generating unit 32 is stored in a memory 51. Then, a processor 52 of the computer executes the program stored in the memory 51.

Furthermore, FIG. 5 illustrates an example in which each of the components of the learning device is implemented by dedicated hardware, and FIG. 6 illustrates an example in which the learning device is implemented by software, firmware, or the like. However, these are merely examples, and some components in the learning device may be implemented by dedicated hardware, and the remaining components may be implemented by software, firmware, or the like.

First, the operation of the learning device illustrated in FIG. 4 will be described.

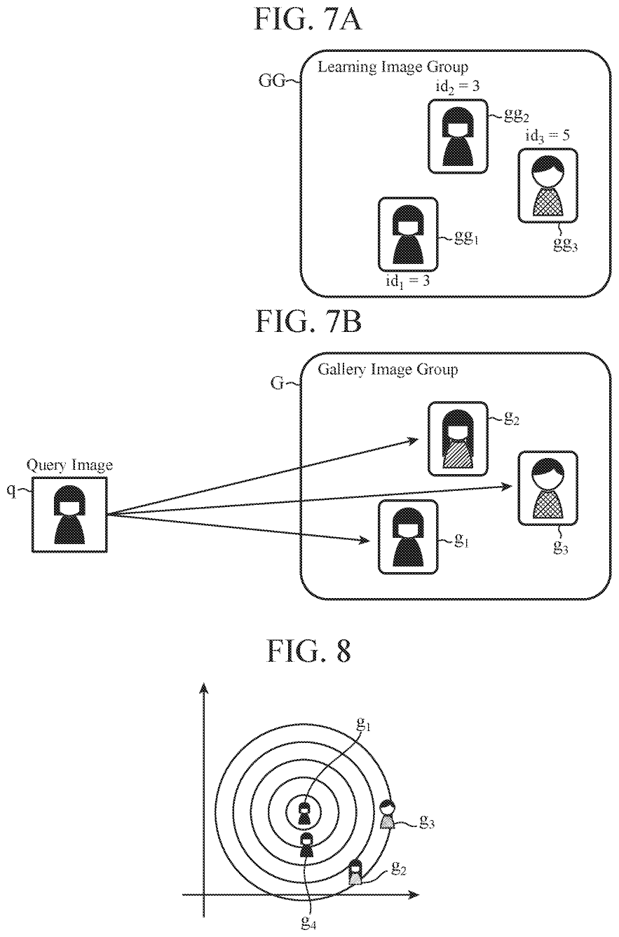

The first learning model generating unit 31 acquires the learning image group GG including M learning images gg₁ to gg_{M} as illustrated in FIG. 7A.

FIG. 7A is an explanatory diagram illustrating an example of the learning image group GG including M learning images gg₁ to gg_{M}.

In the example of FIG. 7A, the learning image group GG includes three learning images gg₁ to gg₃. The identification information id₁ added to the learning image gg₁ is “3,” the identification information id₂ added to the learning image gg₂ is “3,” and the identification information id₃ added to the learning image gg₃ is “5.”

Therefore, in the example of FIG. 7A, the subject included in the learning image gg₁ is the same as the subject included in the learning image gg₂, and the subjects included in the learning images gg₁ and gg₂ are different from the subject included in the learning image gg₃.

The first learning model generating unit 31 extracts a feature vector Fv_{gg,m}, of the learning image ggₘ (m=1, . . . , M). Since the processing itself of extracting the feature vector Fv_{gg,m} of the learning image ggₘ is a known technique, detailed description thereof will be omitted.

The first learning model generating unit 31 gives the learning image ggₘ (m=1, . . . , M) to the first learning model 5 and gives the feature vector Fv_{gg,m} (m=1, . . . , M) to the first learning model 5 as teacher data, thereby causing the first learning model 5 to learn the feature vector Fv_{gg m} of the learning image ggₘ.

When causing the first learning model 5 to learn the feature vector Fv_{gg,m} of the learning image ggₘ, the first learning model generating unit 31 causes the first learning model 5 to learn the feature vector Fv_{gg m} of the learning image ggₘ in such a way that the positions of the learning images, in which the subjects indicated by the identification information idₘ are the same, keep close to each other among the M learning images gg₁ to gg_{M}, as illustrated in FIG. 11. As illustrated in FIG. 11, the first learning model generating unit 31 causes the feature vectors Fv_{gg,m} of the learning images ggₘ to be learned in such a way that the positions of the learning images having the different subjects indicated by the identification information idₘ among the M learning images gg₁ to gg_{M} keep away from each other.

In the learning device illustrated in FIG. 4, the first learning model generating unit 31 causes the feature vector Fv_{gg,m} of the learning image ggₘ to learn by using a distance learning method called Triplet Loss. However, this is merely an example, and the first learning model generating unit 31 may cause the feature vector Fv_{gg,m} of the learning image ggₘ to learn by using a distance learning method other than Triplet Loss.

In the learning device illustrated in FIG. 4, the first learning model generating unit 31 gives the feature vector Fv_{gg,m} of the learning image ggₘ to the first learning model 5, and the first learning model 5 learns the feature vector Fv_{gg,m} of the learning image ggₘ. However, this is merely an example, and the first learning model generating unit 31 may give the learning image ggₘ to the first learning model 5, and the first learning model 5 may extract the feature vector Fv_{gg,m} of the learning image ggₘ and learn the feature vector Fv_{gg,m} of the learning image ggₘ.

FIG. 8 is an explanatory diagram illustrating a position of a learning image ggₘ (m=1, . . . , M) in an image feature space.

In the example of FIG. 8, the positions of the four learning images gg₁ to gg₄ in the image feature space are illustrated.

The image feature space illustrated in FIG. 8 is a two-dimensional feature space. The horizontal axis of the feature space indicates, for example, a distance between the left eye and the right eye of a human who is a subject. The vertical axis of the feature space indicates, for example, the distance from the outer corner of the eye to the nose.

The first learning model generating unit 31 provides the learned first learning model 5 to the feature vector acquiring unit 1 of the image retrieving device illustrated in FIG. 1.

The second learning model generating unit 32 acquires a learning image group GG including learning images gg₁ to ggₘ, which are M learning images.

The second learning model generating unit 32 calculates the reliability Dₘ on the basis of the identification information idₘ added to the learning image ggₘ (m=1, . . . , M).

That is, the second learning model generating unit 32 sequentially acquires each of the learning images ggₘ from the learning image group GG and sets the acquired learning image ggₘ as a reference image gg_{ref}.

The second learning model generating unit 32 calculates, as the reliability Dₘ, a ratio indicating the same subject as the subject indicated by the identification information idₘ added to the reference image gg_{ref} among the identification information id₁ to id_{M} added to the M learning images gg₁ to ggₘ.

For example, if M=10 and the number of learning images ggₘ including the same subject as the subject indicated by the identification information idₘ added to the reference image gg_{ref} is six, the reliability Dₘ is 60=(6/10)×100 [%].

For example, if M=8 and the number of learning images ggₘ including the same subject as the subject indicated by the identification information idₘ added to the reference image gg_{ref} is five, the reliability Dₘ is 62.5=(5/8)×100 [%].

The second learning model generating unit 32 causes the second learning model 6 to learn the reliability Dₘ by giving the learning image ggₘ (m=1, . . . , M) to the second learning model 6 and giving the reliability Dₘ (m=1, . . . , M) to the second learning model 6 as teacher data.

The second learning model generating unit 32 gives the learned second learning model 6 to the reliability acquiring unit 2 of the image retrieving device illustrated in FIG. 1.

Next, the operation of the image retrieving device illustrated in FIG. 1 will be described.

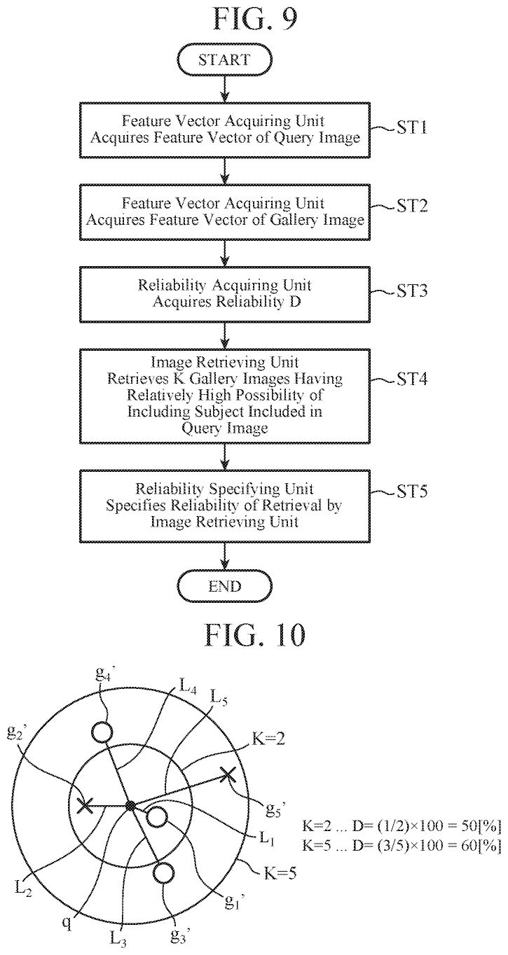

FIG. 9 is a flowchart illustrating an image retrieving method which is a processing procedure performed by of the image retrieving device illustrated in FIG. 1.

The feature vector acquiring unit 1 acquires, for example, a query image q and a gallery image group G including N gallery images g₁ to g_{N} as illustrated in FIG. 7B.

FIG. 7B is an explanatory diagram illustrating an example of the query image q and the gallery image group G.

In the example of FIG. 7B, the gallery image group G includes three gallery images g₁ to g₃.

The feature vector acquiring unit 1 gives the query image q to the first learning model 5 and acquires the feature vector Fv_{q} of the query image q from the first learning model 5 (Step ST1 in FIG. 9).

Moreover, the feature vector acquiring unit 1 gives the gallery image gₙ (n=1, . . . , N) to the first learning model 5 and acquires the feature vector Fv_{g,m} of the gallery image gₙ from the first learning model 5 (Step ST2 in FIG. 9).

The feature vector acquiring unit 1 outputs, to the image retrieving unit 3, each of the gallery image group G, the feature vector Fv_{q} of the query image q, and the feature vector Fv_{g,m} of the gallery image gₙ.

The reliability acquiring unit 2 acquires the query image q.

The reliability acquiring unit 2 gives the query image q to the second learning model 6 and acquires the reliability D from the second learning model 6 (Step ST3 in FIG. 9).

The reliability acquiring unit 2 outputs the reliability D to the reliability specifying unit 4.

The image retrieving unit 3 acquires each of the gallery image group G, the feature vector Fv_{q} of the query image q, and the feature vector Fv_{g,m} of the gallery image gₙ (n=1, . . . , N) from the feature vector acquiring unit 1.

The image retrieving unit 3 calculates a Euclidean distance Lₙ between the feature vector Fv_{q} of the query image q and the feature vector Fv_{g,m} of the gallery image gₙ as the similarity Sₙ between the query image q and the gallery image gₙ (n=1, . . . , N). The shorter the Euclidean distance Lₙ, the higher the similarity Sₙ between the query image q and the gallery image gₙ. Since the calculation processing of the Euclidean distance Lₙ itself is a known technique, detailed description thereof will be omitted.

From the N gallery images g₁ to g_{N}, the image retrieving unit 3 retrieves K gallery images to g_{K}′ having a relatively high similarity Sₙ with the query image q as K gallery images g₁′ to g_{K}′ having a relatively high possibility of including the subject included in the query image q (Step ST4 in FIG. 9).

FIG. 10 is an explanatory diagram illustrating K gallery images g₁′ to g_{K}′ having a relatively high possibility of including a subject included in a query image q.

In the example of FIG. 10, five gallery images g₁′ to g₅′ are represented as K gallery images to g_{K}′.

In FIG. 10, ⋅ is the query image q, ○ is the gallery image including the subject included in the query image q, and x is the gallery image not including the subject included in the query image q.

The similarity Sₖ of the gallery image gₖ′ (k=1, . . . , K) to the query image q is represented by a Euclidean distance Lₖ between the feature vector Fv_{q} of the query image q and the feature vector Fv_{g,k} of the gallery image gₖ′.

In the example of FIG. 10, since L₁<L₂<L₃<L₄<L₅, the similarity Sₖ of the gallery image gₖ′ to the query image q is S₁>S₂>S₃>S₄>S₅.

Herein, the similarity Sₖ of the gallery image gₖ′ to the query image q is represented by the Euclidean distance Lₖ. However, this is merely an example, and the similarity Sₖ may be represented by, for example, cosine similarity of the gallery image gₖ′ with respect to the query image q.

In the example of FIG. 10, in a case of K=2, there are a gallery image g₁′ including the subject included in the query image q and a gallery image g₂′ not including the subject included in the query image q among the K gallery images g₁′ to g_{K}′.

In the case of K=2, the image retrieving unit 3 outputs the gallery images g₁′ and g₂′ to the outside as K gallery images g₁′ to g_{K}′ having a relatively high possibility of including the subject included in the query image q.

Moreover, in the case of K=5, there are the gallery images g₁′, g₃′, and g₄′ including the subject included in the query image q and the gallery images g₂′ and g₅′ not including the subject included in the query image q among the K gallery images g₁′ to g_{K}′.

In the case of K=5, the image retrieving unit 3 outputs the gallery images g₁′, g₂′, g₃′, g₄′, and g₅′ to the outside as the K gallery images g₁′ to g_{K}′ having a relatively high possibility of including the subject included in the query image q.

The image retrieving unit 3 outputs the K gallery images g₁′ to g_{K}′ to the outside as image retrieval results, thereby causing a display or the like to display the K gallery images g₁′ to g_{K}′, for example.

The reliability specifying unit 4 acquires the reliability D from the reliability acquiring unit 2.

The reliability specifying unit 4 specifies the reliability of the retrieval by the image retrieving unit 3 from the reliability D acquired by the reliability acquiring unit 2 (Step ST5 in FIG. 9).

In the image retrieving device illustrated in FIG. 1, the reliability specifying unit 4 directly specifies the reliability D acquired by the reliability acquiring unit 2 as the reliability of the retrieval by the image retrieving unit 3.

The reliability specifying unit 4 outputs the reliability D of the retrieval by the image retrieving unit 3 to the outside, thereby causing a display or the like to display the reliability D of the retrieval by the image retrieving unit 3, for example.

In the example of FIG. 10, in a case of K=2, since the gallery image g₁′ including the subject included in the query image q and the gallery image g₂′ not including the subject included in the query image q are retrieved by the image retrieving unit 3, it is assumed that the reliability D is 50=(1/2)×100 [%].

In the example of FIG. 10, in a case of K=5, since the gallery images g₁′, g₃′, g₄′ including the subject included in the query image q and the gallery images g₂′, g₅′ not including the subject included in the query image q are retrieved by the image retrieving unit 3, it is assumed that the reliability D is 60=(3/5)×100[%].

In the first embodiment described above, the image retrieving device includes: the feature vector acquiring unit 1 to give a query image that is an image to be identified to the first learning model 5, acquire a feature vector of the query image from the first learning model 5, give each of a plurality of gallery images that are images to be identified to the first learning model 5, and acquire a feature vector of each of the gallery images from the first learning model 5; and the reliability acquiring unit 2 to give the query image to the second learning model 6, and acquire, from the second learning model 6, reliability of retrieval when K (K is an integer equal to or more than one) gallery images having a relatively high possibility of including a subject included in the query image among the plurality of gallery images are retrieved. Moreover, the image retrieving device further includes: the image retrieving unit 3 to retrieve K gallery images from among the plurality of gallery images on the basis of the feature vector of the query images and the feature vector of each of the gallery images acquired by the feature vector acquiring unit 1; and a reliability specifying unit 4 to specify the reliability of the retrieval by the image retrieving unit 3 from the reliability acquired by the reliability acquiring unit 2. Therefore, the image retrieving device can check the reliability of retrieval by the image retrieving unit 3.

### Second Embodiment

In a second embodiment, an image retrieving device will be described in which a reliability acquiring unit 61 gives a query image q to a second learning model 63 and acquires the reliability of the group from the second learning model 63 as the reliability of retrieval.

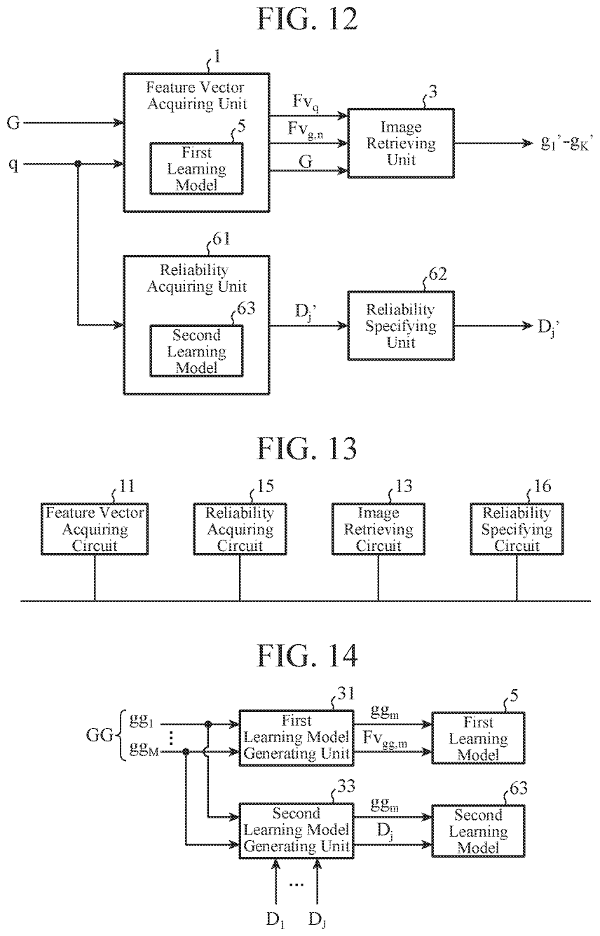

FIG. 12 is a configuration diagram illustrating an image retrieving device according to the second embodiment. In FIG. 12, the same reference signs as those in FIG. 1 denote the same or corresponding parts, and thus the description thereof is omitted.

FIG. 13 is a hardware configuration diagram illustrating hardware of the image retrieving device according to the second embodiment. In FIG. 13, the same reference signs as those in FIG. 2 denote the same or corresponding parts, and thus the description thereof is omitted.

The image retrieving device illustrated in FIG. 12 includes a feature vector acquiring unit 1, a reliability acquiring unit 61, an image retrieving unit 3 and a reliability specifying unit 62.

The M learning images gg₁ to gg_{M} are grouped by reliability. The M learning images gg₁ to gg_{M} are classified into, for example, J groups GP₁ to GP_{J}−. J is an integer equal to or more than one and equal to or less than M.

If J=3 and M=16, for example, there is a case where the learning images gg₁ to gg₃ are classified into the group GP₁ with the reliability ○○%, the learning images gg₄ to gg₁₀ are classified into the group GP₂ with the reliability ΔΔ%, and the learning images gg₁₁ to gg₁₆ are classified into the group GP₃with the reliability □□%.

The second learning model 63 is a learning model in which the learning of the reliability Dⱼ for the group GPⱼ is performed when the learning image ggₘ (m=1, . . . , M) and the reliability Dⱼ for the group GPⱼ including the learning image ggₘ are given.

The reliability acquiring unit 61 is implemented by, for example, a reliability acquiring circuit 15 illustrated in FIG. 13.

The reliability acquiring unit 61 includes a second learning model 63. The second learning model 63 is generated by a learning device illustrated in FIG. 14.

The reliability acquiring unit 61 acquires a query image q.

The reliability acquiring unit 61 gives the query image q to the second learning model 63 and acquires the reliability Dⱼ′ for the group GPⱼ′ as the reliability of the retrieval when K gallery images g₁′ to g_{K}′ having a relatively high possibility of including the subject included in the query image q among the N gallery images g₁ to g_{N} are retrieved from the second learning model 63.

The reliability acquiring unit 61 outputs the reliability Dⱼ′ for the group GPⱼ′ to the reliability specifying unit 62.

The reliability specifying unit 62 is implemented by, for example, a reliability specifying circuit 16 illustrated in FIG. 13.

The reliability specifying unit 62 acquires the reliability Dⱼ′ for the group GPⱼ′ from the reliability acquiring unit 61.

The reliability specifying unit 62 specifies the reliability of the retrieval by the image retrieving unit 3 from the reliability Dⱼ′ for the group GPⱼ′ acquired by the reliability acquiring unit 61.

In the image retrieving device illustrated in FIG. 12, the reliability specifying unit 62 outputs the reliability Dⱼ′ of the group GPⱼ′ acquired by the reliability acquiring unit 61 to the outside as the reliability of the retrieval by the image retrieving unit 3.

The reliability specifying unit 62 outputs the reliability Dⱼ′ of the retrieval by the image retrieving unit 3 to the outside, thereby causing a display or the like to display the reliability Dⱼ′ of the retrieval by the image retrieving unit 3, for example.

In FIG. 12, it is assumed that each of the feature vector acquiring unit 1, the reliability acquiring unit 61, the image retrieving unit 3 and the reliability specifying unit 62, which are components of the image retrieving device, is implemented by dedicated hardware as illustrated in FIG. 13. That is, it is assumed that the image retrieving device is implemented by the feature vector acquiring circuit 11, the reliability acquiring circuit 15, the image retrieving circuit 13 and the reliability specifying circuit 16.

Each of the feature vector acquiring circuit 11, the reliability acquiring circuit 15, the image retrieving circuit 13 and the reliability specifying circuit 16 corresponds to, for example, a single circuit, a composite circuit, a programmed processor, a parallel-programmed processor, ASIC, FPGA or a combination thereof.

The components of the image retrieving device are not limited to those implemented by dedicated hardware, and the image retrieving device may be implemented by software, firmware, or a combination of software and firmware.

In a case where the image retrieving device is implemented by software, firmware, or the like, a program for causing a computer to execute each processing procedure performed in the feature vector acquiring unit 1, the reliability acquiring unit 61, the image retrieving unit 3, and the reliability specifying unit 62 is stored in the memory 21 illustrated in FIG. 3. Then, the processor 22 illustrated in FIG. 3 executes the program stored in the memory 21.

Furthermore, FIG. 13 illustrates an example in which each of the components of the image retrieving device is implemented by dedicated hardware, and FIG. 3 illustrates an example in which the image retrieving device is implemented by software, firmware, or the like. However, these are merely examples, and some components in the image retrieving device may be implemented by dedicated hardware, and the remaining components may be implemented by software, firmware, or the like.

FIG. 14 is a configuration diagram illustrating a learning device that generates each of the first learning model 5 and the second learning model 63 used by the image retrieving device illustrated in FIG. 12.

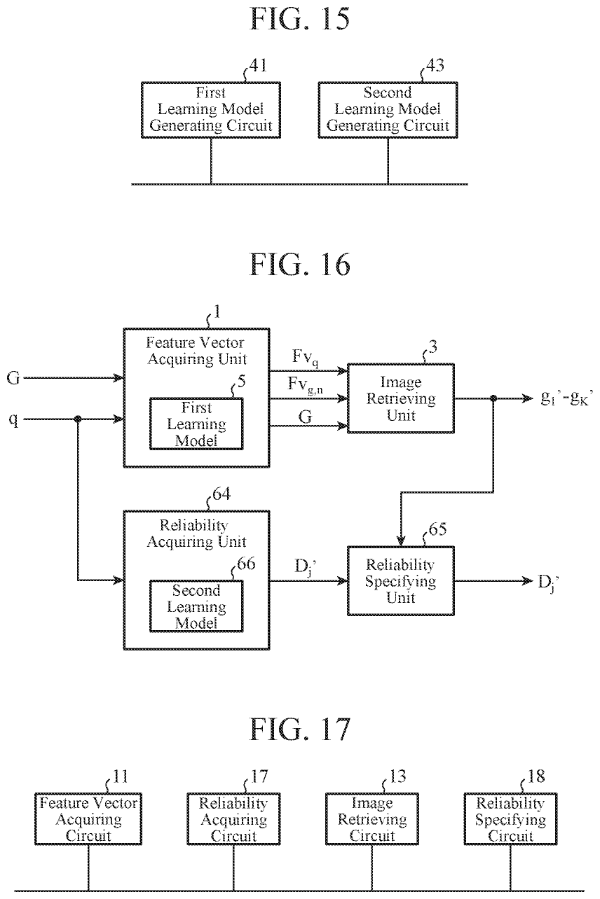

FIG. 15 is a hardware configuration diagram illustrating hardware of the learning device illustrated in FIG. 14.

The learning device illustrated in FIG. 14 includes a first learning model generating unit 31 and a second learning model generating unit 33.

The second learning model generating unit 33 is implemented by, for example, a second learning model generating circuit 43 illustrated in FIG. 15.

The second learning model generating unit 33 acquires a learning image group GG including learning images gg₁ to ggₘ, which are M learning images.

The second learning model generating unit 33 acquires the reliability Dⱼ for the group GPⱼ (j=1, . . . , J) including the learning image ggₘ (m=1, . . . , M).

The second learning model generating unit 33 generates the second learning model 63 by using the learning image ggₘ (m=1, . . . , M) and the reliability Dⱼ for the group GPⱼ (j=1, . . . , J).

That is, the second learning model generating unit 33 gives the learning image ggₘ (m=1, . . . , M) to the second learning model 63 and gives the reliability Dⱼ for the group GPⱼ to the second learning model 63 as teacher data, thereby causing the second learning model 63 to learn the reliability Dⱼ for the group GPⱼ.

The second learning model generating unit 33 gives the learned second learning model 63 to the reliability acquiring unit 61 of the image retrieving device illustrated in FIG. 12.

In FIG. 14, it is assumed that each of the first learning model generating unit 31 and the second learning model generating unit 33, which are components of the learning device, is implemented by dedicated hardware as illustrated in FIG. 15. That is, it is assumed that the learning device is implemented by the first learning model generating circuit 41 and the second learning model generating circuit 43.

Each of the first learning model generating circuit 41 and the second learning model generating circuit 43 corresponds to, for example, a single circuit, a composite circuit, a programmed processor, a parallel-programmed processor, ASIC, FPGA or a combination thereof.

The components of the learning device are not limited to those implemented by dedicated hardware, and the learning device may be implemented by software, firmware, or a combination of software and firmware.

In a case where the learning device is implemented by software, firmware, or the like, a program for causing a computer to execute each processing procedure in the first learning model generating unit 31 and the second learning model generating unit 33 is stored in the memory 51 illustrated in FIG. 6. Then, the processor 52 illustrated in FIG. 6 executes the program stored in the memory 51.

Furthermore, FIG. 15 illustrates an example in which each of the components of the learning device is implemented by dedicated hardware, and FIG. 6 illustrates an example in which the learning device is implemented by software, firmware, or the like. However, these are merely examples, and some components in the learning device may be implemented by dedicated hardware, and the remaining components may be implemented by software, firmware, or the like.

First, the operation of the learning device illustrated in FIG. 14 will be described. Since the learning device is similar to the learning device illustrated in FIG. 4 except for the second learning model generating unit 33, only the operation of the second learning model generating unit 33 will be described herein.

In the learning device illustrated in FIG. 14, the M learning images gg₁ to gg_{M} are grouped by reliability. That is, the M learning images gg₁ to gg M are classified into, for example, J groups GP₁ to GP_{J}.

The second learning model generating unit 33 acquires a learning image group GG including learning images gg₁ to gg_{M}, which are M learning images.

Moreover, the second learning model generating unit 33 acquires the reliability Dⱼ for the group GPⱼ (j=1, . . . , J) including the learning image ggₘ (m=1, . . . , M).

The second learning model generating unit 33 may recognize the group GPⱼ including the learning image ggₘ in advance, or may acquire information indicating the group GPⱼ including the learning image ggₘ from the outside.

The second learning model generating unit 33 gives the learning image ggₘ (m=1, . . . , M) to the second learning model 63 and gives the reliability Dⱼ for the group GPⱼ to the second learning model 63 as teacher data, thereby causing the second learning model 63 to learn the reliability Dⱼ for the group GPⱼ.

The second learning model generating unit 33 gives the learned second learning model 63 to the reliability acquiring unit 61 of the image retrieving device illustrated in FIG. 12.

Next, the operation of the image retrieving device illustrated in FIG. 12 will be described. Since the operations other than the reliability acquiring unit 61 and the reliability specifying unit 62 are similar to those of the image retrieving device illustrated in FIG. 1, only the operations of the reliability acquiring unit 61 and the reliability specifying unit 62 will be described here.

The reliability acquiring unit 61 acquires a query image q.

The reliability acquiring unit 61 gives the query image q to the second learning model 63 and acquires the reliability Dⱼ′ for the group GPⱼ′ from the second learning model 63.

The reliability acquiring unit 61 outputs the reliability Dⱼ′ for the group GPⱼ′ to the reliability specifying unit 62.

The reliability specifying unit 62 acquires the reliability Dⱼ′ for the group GPⱼ′ from the reliability acquiring unit 61.

The reliability specifying unit 62 specifies the reliability of the retrieval by the image retrieving unit 3 from the reliability Dⱼ′ for the group GPⱼ′ acquired by the reliability acquiring unit 61.

That is, the reliability specifying unit 62 sets the reliability Dⱼ′ for the group GPⱼ′ as the reliability of the retrieval by the image retrieving unit 3.

The reliability specifying unit 62 outputs the reliability Dⱼ′ of the retrieval by the image retrieving unit 3 to the outside, thereby causing a display or the like to display the reliability Dⱼ′ of the retrieval by the image retrieving unit 3, for example.

In the second embodiment described above, learning images, which are a plurality of images for learning, are grouped by reliability, and the second learning model 63 is a learning model in which learning of reliability is performed when each learning image is given and the reliability for a group including each learning image is given as teacher data. The reliability acquiring unit 61 of the image retrieving device illustrated in FIG. 12 gives the query image to the second learning model 63 and acquires the reliability of the group as the reliability of retrieval when K gallery images having a relatively high possibility of including the subject included in the query image are retrieved from the second learning model 63. The reliability specifying unit 62 of the image retrieving device illustrated in FIG. 12 specifies the reliability of the retrieval by the image retrieving unit 3 from the reliability of the group acquired by the reliability acquiring unit 61. Therefore, the image retrieving device illustrated in FIG. 12 can check the reliability of retrieval by the image retrieving unit 3 like the image retrieving device illustrated in FIG. 1.

### Third Embodiment

In a third embodiment, an image retrieving device will be described in which a reliability acquiring unit 64 gives a query image q to a second learning model 66 and acquires the reliability of a distance class from the second learning model 66 as the reliability of retrieval.

FIG. 16 is a configuration diagram illustrating the image retrieving device according to the third embodiment. In FIG. 16, the same reference signs as those in FIGS. 1 and 12 denote the same or corresponding parts, and thus the description thereof is omitted.

FIG. 17 is a hardware configuration diagram illustrating hardware of the image retrieving device according to the third embodiment. In FIG. 17, the same reference signs as those in FIGS. 2 and 13 denote the same or corresponding parts, and thus the description thereof is omitted.

The image retrieving device illustrated in FIG. 16 includes a feature vector acquiring unit 1, a reliability acquiring unit 64, an image retrieving unit 3 and a reliability specifying unit 65.

The M learning images gg₁ to gg_{M} included in the learning image group GG are classified into, for example, U distance classes CLᵤ (u=1, . . . , U). U is an integer equal to or more than one and equal to or less than M.

That is, each of the M learning images gg₁ to gg_{M} is sequentially set as the reference image gg_{ref}. The degree of similarity between each of the reference images gg_{ref} and the learning image ggₘ′ that is included in the learning image group GG and is each of the learning images ggₘ other than the reference image gg_{ref} is represented by the distance between the position of the reference image gg_{ref} in the image space and the position of each of the learning images ggₘ′ in the image space.

Then, each learning image ggₘ′ is classified into any one of the U distance classes CL₁ to CLᵤ depending on the distance to the reference image gg_{ref}.

The second learning model 66 is a learning model in which the degree of reliability Dᵤ for the distance class CLᵤ is learned when the reference image gg_{ref} and the degree of reliability Dᵤ for the distance class CLᵤ (u=1, . . . , U) are given.

The reliability D u for the distance class CLᵤ is calculated from a first frequency Pᵤ that is a ratio of the learning image including the subject included in the reference image gg_{ref} and a second frequency Pᵤ′ that is a ratio of the learning image not including the subject included in the reference image gg_{ref} among the learning images ggₘ included in the distance class CLᵤ, as shown in the following expression (1).

Dᵤ=Pᵤ/(Pᵤ+Pᵤ′) (1)

The reliability acquiring unit 64 is implemented by, for example, a reliability acquiring circuit 17 illustrated in FIG. 17.

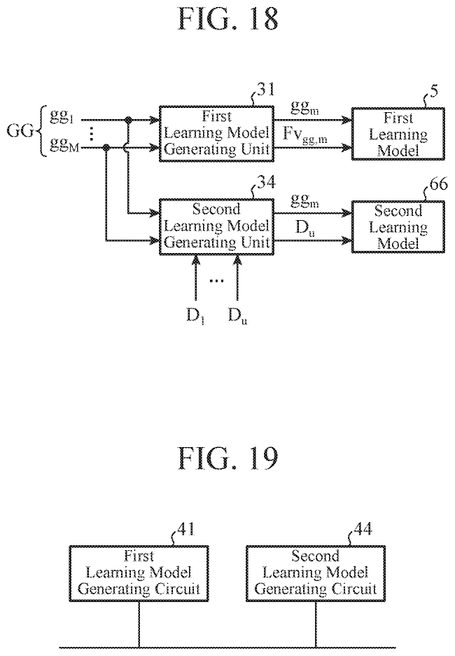

The reliability acquiring unit 64 includes a second learning model 66. The second learning model 66 is generated by a learning device illustrated in FIG. 18.

The reliability acquiring unit 64 acquires a query image q.

The reliability acquiring unit 64 gives the query image q to the second learning model 66 and acquires the reliability Dᵤ′ of the distance class CLᵤ′ (u=1, . . . , U) as the reliability of the retrieval when K gallery images g₁′ to g_{K}′ having a relatively high possibility of including the subject included in the query image q among the N gallery images g₁ to g_{N} are retrieved from the second learning model 66.

The reliability acquiring unit 64 outputs the reliability Dᵤ′ of the distance class CLᵤ′ to the reliability specifying unit 65.

The reliability specifying unit 65 is implemented by, for example, a reliability specifying circuit 18 illustrated in FIG. 17.

The reliability specifying unit 65 acquires the reliability Dᵤ′ for the distance class CLᵤ′ (u=1, . . . , U) from the reliability acquiring unit 64.

The reliability specifying unit 65 acquires the reliability Dₖ′ of the distance class CLₖ′ including the gallery image gₖ′ (k=1, . . . , K) retrieved by the image retrieving unit 3 from the U distance classes CL₁′ to CLᵤ′ as the reliability of the retrieval by the image retrieving unit 3.

The reliability specifying unit 65 calculates the reliability of the retrieval by the image retrieving unit 3 from the acquired reliability Dₖ′ of the distance class CLₖ′.

The reliability specifying unit 65 outputs the reliability of the retrieval by the image retrieving unit 3 to the outside, thereby causing a display or the like to display the reliability of the retrieval by the image retrieving unit 3, for example.

In FIG. 16, it is assumed that each of the feature vector acquiring unit 1, the reliability acquiring unit 64, the image retrieving unit 3 and the reliability specifying unit 65, which are components of the image retrieving device, is implemented by dedicated hardware as illustrated in FIG. 17. That is, it is assumed that the image retrieving device is implemented by the feature vector acquiring circuit 11, the reliability acquiring circuit 17, the image retrieving circuit 13 and the reliability specifying circuit 18.

Each of the feature vector acquiring circuit 11, the reliability acquiring circuit 17, the image retrieving circuit 13 and the reliability specifying circuit 18 corresponds to, for example, a single circuit, a composite circuit, a programmed processor, a parallel-programmed processor, ASIC, FPGA or a combination thereof.

The components of the image retrieving device are not limited to those implemented by dedicated hardware, and the image retrieving device may be implemented by software, firmware, or a combination of software and firmware.

In a case where the image retrieving device is implemented by software, firmware, or the like, a program for causing a computer to execute each processing procedure performed in the feature vector acquiring unit 1, the reliability acquiring unit 64, the image retrieving unit 3, and the reliability specifying unit 65 is stored in the memory 21 illustrated in FIG. 3. Then, the processor 22 illustrated in FIG. 3 executes the program stored in the memory 21.

Furthermore, FIG. 17 illustrates an example in which each of the components of the image retrieving device is implemented by dedicated hardware, and FIG. 3 illustrates an example in which the image retrieving device is implemented by software, firmware, or the like. However, these are merely examples, and some components in the image retrieving device may be implemented by dedicated hardware, and the remaining components may be implemented by software, firmware, or the like.

FIG. 18 is a configuration diagram illustrating a learning device that generates each of the first learning model 5 and the second learning model 66 used by the image retrieving device illustrated in FIG. 16.

FIG. 19 is a hardware configuration diagram illustrating hardware of the learning device illustrated in FIG. 18.

The learning device illustrated in FIG. 19 includes a first learning model generating unit 31 and a second learning model generating unit 34.

The second learning model generating unit 34 is implemented by, for example, a second learning model generating circuit 44 illustrated in FIG. 19.

The second learning model generating unit 34 acquires a learning image group GG including learning images gg₁ to gg_{M}, which are M learning images.

The second learning model generating unit 34 acquires the reliability Dᵤ for the distance class CLᵤ (u=1, . . . , U) including the learning image ggₘ (m=1, . . . , M).

The second learning model generating unit 34 generates the second learning model 66 by using the learning image ggₘ (m=1, . . . , M) and the reliability Dᵤ for the distance class CLᵤ (u=1, . . . , U).

That is, the second learning model generating unit 34 sequentially sets each of the M learning images gg₁ to gg_{M} as the reference image gg_{ref}.

Then, the second learning model generating unit 34 gives the set reference image gg_{ref} to the second learning model 66 and gives the teacher data to the second learning model 66, thereby causing the second learning model 66 to learn the reliability Dᵤ for the distance class CLᵤ (u=1, . . . , U). The teacher data is the reliability Dᵤ for the distance class CLᵤ (u=1, . . . , U) including the learning image ggₘ′, which is each learning image ggₘ other than the set reference image gg_{ref}, among the learning images gg₁ to gg_{M} included in the learning image group GG.

The second learning model generating unit 34 gives the learned second learning model 66 to the reliability acquiring unit 64 of the image retrieving device illustrated in FIG. 16.

In FIG. 18, it is assumed that each of the first learning model generating unit 31 and the second learning model generating unit 34, which are components of the learning device, is implemented by dedicated hardware as illustrated in FIG. 19. That is, it is assumed that the learning device is implemented by the first learning model generating circuit 41 and the second learning model generating circuit 44.

Each of the first learning model generating circuit 41 and the second learning model generating circuit 44 corresponds to, for example, a single circuit, a composite circuit, a programmed processor, a parallel-programmed processor, ASIC, FPGA or a combination thereof.

The components of the learning device are not limited to those implemented by dedicated hardware, and the learning device may be implemented by software, firmware, or a combination of software and firmware.

In a case where the learning device is implemented by software, firmware, or the like, a program for causing a computer to execute each processing procedure in the first learning model generating unit 31 and the second learning model generating unit 34 is stored in the memory 51 illustrated in FIG. 6. Then, the processor 52 illustrated in FIG. 6 executes the program stored in the memory 51.

Furthermore, FIG. 19 illustrates an example in which each of the components of the learning device is implemented by dedicated hardware, and FIG. 6 illustrates an example in which the learning device is implemented by software, firmware, or the like. However, these are merely examples, and some components in the learning device may be implemented by dedicated hardware, and the remaining components may be implemented by software, firmware, or the like.

First, the operation of the learning device illustrated in FIG. 18 will be described. Since the learning device is similar to the learning device illustrated in FIG. 4 except for a second learning model generating unit 34, only the operation of the second learning model generating unit 34 will be described herein.

In the learning device illustrated in FIG. 18, each of the M learning images gg₁ to gg_{M} is sequentially set as the reference image gg_{ref}. Then, the degree of the similarity between each reference image gg_{ref} and the learning image ggₘ′ (m=1, . . . , M−1) is represented by a distance between the position of the reference image gg_{ref} in the image space and the position of the learning image ggₘ (m=1, . . . , M−1) in the image space.

For example, if M=5 and the reference image gg_{ref} is the learning image gg₂, the learning image gg₁′ is the learning image gg₁, the learning image gg₂′ is the learning image gg₃, the learning image gg₃′ is the learning image gg₄, and the learning image gg₄′ is the learning image gg₅.

For example, if M=5 and the reference image gg_{ref} is the learning image gg₃, the learning image gg₁′ is the learning image gg₁, the learning image gg₂′ is the learning image gg₂, and the learning image gg₃′ is the learning image gg₄, and the learning image gg₄′ is the learning image gg₅.

The learning image ggₘ′ (m=1, . . . , M−1) is classified into any one of the distance classes CLᵤ (u=1, . . . , U) of the U distance classes CL₁ to CLᵤ depending on the distance to the reference image gg_{ref}.

The second learning model generating unit 34 acquires a learning image group GG including learning images gg₁ to gg_{M}, which are M learning images.

The second learning model generating unit 34 acquires the reliability Dᵤ for the distance class CLᵤ (u=1, . . . , U) including the learning image ggₘ (m=1, . . . , M).

That is, the second learning model generating unit 34 sequentially sets each of the M learning images gg₁ to gg_{M} as the reference image gg_{ref} and acquires the reliability Dᵤ for the distance class CLᵤ (u=1, . . . , U) including the learning image gg′ that is each learning image ggₘ other than the set reference image gg_{ref} among the M learning images gg₁ to gg_{M}.

The second learning model generating unit 34 gives the set reference image gg_{ref} to the second learning model 66 and gives the teacher data to the second learning model 66, thereby causing the second learning model 66 to learn the reliability Dᵤ for the distance class CLᵤ (u=1, . . . , U). The teacher data is the reliability Dᵤ for the distance class CLᵤ (u=1, . . . , U) including the (M−1) learning images gg₁′ to gg_{M-1}.

The second learning model generating unit 34 gives the learned second learning model 66 to the reliability acquiring unit 64 of the image retrieving device illustrated in FIG. 16.

Next, the operation of the image retrieving device illustrated in FIG. 16 will be described. Since the operations other than the reliability acquiring unit 64 and the reliability specifying unit 65 are similar to those of the image retrieving device illustrated in FIG. 1, only the operations of the reliability acquiring unit 64 and the reliability specifying unit 65 will be described here.

The reliability acquiring unit 64 acquires a query image q.

The reliability acquiring unit 64 gives the query image q to the second learning model 66 and acquires the reliability Dᵤ′ for the distance class CLᵤ′ (u=1, . . . , U) from the second learning model 66.

The reliability acquiring unit 64 outputs the reliability Dᵤ′ of the distance class CLᵤ′ to the reliability specifying unit 65.

The reliability Dᵤ′ for the distance class CLᵤ′ can be calculated from a first frequency Pᵤ, which is a ratio of the gallery image including the subject included in the query image q, and a second frequency Pᵤ′, which is a ratio of the gallery image not including the subject included in the query image q, among the gallery images gₙ (n=1, . . . , N) included in the distance class CLᵤ′, as shown in the following expression (2).

Dᵤ′=Pᵤ/(Pᵤ+Pᵤ′) (2)

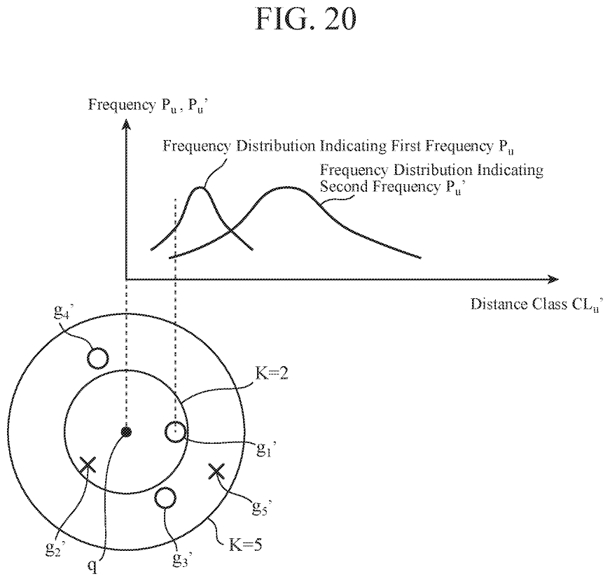

FIG. 20 is an explanatory diagram illustrating a frequency distribution of gallery images including a subject included in a query image and a frequency distribution of the gallery image not including the subject included in the query image.

In FIG. 20, the horizontal axis indicates the distance class CLᵤ′ (u=1, . . . , U). The vertical axis indicates each of the first frequency Pᵤ and the second frequency Pᵤ′.

FIG. 20 illustrates one query image qₕ and five gallery images g₁ to g₅.

The reliability specifying unit 65 acquires the reliability Dᵤ′ for the distance class CLu′ (u=1, . . . , U) from the reliability acquiring unit 64.

The reliability specifying unit 65 acquires K gallery images to g_{K}′ from the image retrieving unit 3 and acquires the Euclidean distance Lₖ between the feature vector Fv_{q} of the query image q and the gallery image gₖ′ (k=1, . . . , H) from the image retrieving unit 3.

The reliability specifying unit 65 specifies the distance class CLₖ ′ including the gallery image gₖ′ among the U distance classes CL₁′ to CLᵤ′ on the basis of the Euclidean distance Lₖ between the feature vector Fv_{q} of the query image q and the gallery image gₖ′ (k=1, . . . , H).

Then, the reliability specifying unit 65 specifies the reliability Dₖ′ of the distance class CLk′ including the gallery image gₖ′ (k=1, . . . , K) retrieved by the image retrieving unit 3 from the reliability Dᵤ′ of the U distance classes CL₁′ to CLᵤ′.

For example, when K=2 and the gallery image gₖ′ retrieved by the image retrieving unit 3 is the gallery images and g₂′, the reliability specifying unit 65 acquires the reliability Dₖ′ for the distance class CLₖ′ including the gallery image and the reliability Dₖ′ for the distance class CLₖ′ including the gallery image g₂′.

For example, when K=5 and the gallery image gₖ′ retrieved by the image retrieving unit 3 is the gallery images g₄′ and g₅′ the reliability specifying unit 65 acquires the reliability Dₖ′ for the distance class CLₖ′ including the gallery image and the reliability Dₖ′ for the distance class CLₖ′ including the gallery image g₂′ . Moreover, the reliability specifying unit 65 acquires the reliability Dₖ′ for the distance class CLₖ′ including the gallery image g₃′, the reliability Dₖ′ for the distance class CLₖ′ including the gallery image g₄′, and the reliability Dₖ′ for the distance class CLₖ′ including the gallery image g₅′.

When the number of the gallery images gₖ′ retrieved by the image retrieving unit 3 is one and the number of the reliability Dₖ′ for the acquired distance class CLₖ′ is one, the reliability specifying unit 65 outputs the reliability Dₖ′ for one distance class CLₖ′ to the outside as the reliability Dⱼ′ of the retrieval by the image retrieving unit 3.

When the number of the gallery images gₖ′ retrieved by the image retrieving unit 3 is plural and the number of the reliabilities Dₖ′ for the acquired distance classes CLₖ′ is plural, the reliability specifying unit 65 calculates an average value, a median value, or the like of the reliabilities Dₖ′ for the plurality of distance classes CLₖ′ as the reliability Dⱼ of the retrieval by the image retrieving unit 3.

The reliability specifying unit 65 outputs the reliability Dⱼ′ of the retrieval by the image retrieving unit 3 to the outside, thereby causing a display or the like to display the reliability Dⱼ′ of the retrieval by the image retrieving unit 3, for example.

In the third embodiment described above, the image retrieving device illustrated in FIG. 16 is configured in such a way that the reliability acquiring unit 64 gives the query image to the second learning model 66, acquires the reliability for the plurality of distance classes as the reliability of the retrieval when the K gallery images having a relatively high possibility of including the subject included in the query image are retrieved from the second learning model 66, and the reliability specifying unit 65 acquires the reliability for the distance class including the K gallery images retrieved by the image retrieving unit 3 from the reliability for the plurality of distance classes acquired by the reliability acquiring unit 64, and calculates the reliability of the retrieval by the image retrieving unit 3 from the acquired reliability for the distance class. Therefore, the image retrieving device illustrated in FIG. 16 can check the reliability of retrieval by the image retrieving unit 3 like the image retrieving device illustrated in FIG. 1.

Note that, in the present disclosure, it is possible to freely combine each of the embodiments, to modify any components of each embodiment, or to omit any components in each embodiment.

### INDUSTRIAL APPLICABILITY

The present disclosure is suitable for an image retrieving device and an image retrieving method.

### REFERENCE SIGNS LIST

1: feature vector acquiring unit, 2, 61, 64: reliability acquiring unit, 3: image retrieving unit, 4, 62, 65: reliability specifying unit, 5: first learning model, 6, 63, 66: second learning model, 11: feature vector acquiring circuit, 12, 15, 17: reliability acquiring circuit, 13: image retrieving circuit, 14, 16, 18: reliability specifying circuit, 21: memory, 22: processor, 31: first learning model generating unit, 32, 33, 34: second learning model generating unit, 41: first learning model generating circuit, 42, 43, 44: second learning model generating circuit, 51: memory, 52: processor

1. An image retrieving device comprising:
processing circuitry configured to
give a query image that is an image to be identified to a first learning model, acquire a feature vector of the query image from the first learning model, give each of a plurality of gallery images that are images to be identified to the first learning model, and acquire a feature vector of each of the gallery images from the first learning model;
give the query image to a second learning model, and acquire, from the second learning model, reliability of retrieval when K (K is an integer equal to or more than one) gallery images having a relatively high possibility of including a subject included in the query image are retrieved from the plurality of the gallery images;
retrieve the K gallery images from the plurality of the gallery images on a basis of the feature vector of the acquired query image and the feature vector of each of the gallery images; and
specify the reliability of retrieval from the acquired reliability.

2. The image retrieving device according to claim 1, wherein
the second learning model is a learning model in which each of learning images that are a plurality of images for learning included in a learning image group is sequentially given as a reference image, and learning of the reliability is performed when the reliability of retrieval at a time when K learning images having a relatively high possibility of including a subject included in the reference image are retrieved from among learning images other than the reference image included in the learning image group is given as teacher data.

3. The image retrieving device according to claim 1, wherein learning images, which are a plurality of images for learning, are grouped by the reliability,
the second learning model is a learning model in which learning of the reliability is performed when each of the learning images is given and the reliability for a group including each of the learning images is given as teacher data,
the processing circuitry is further configured to
give the query image to the second learning model and acquire reliability of the group as the reliability of retrieval when K gallery images having a relatively high possibility of including a subject included in the query image are retrieved from the second learning model, and
specify the reliability of retrieval from the acquired reliability of the group.

4. The image retrieving device according to claim 1, wherein each of learning images that are a plurality of images for learning included in a learning image group is sequentially set as a reference image, a degree of similarity between each reference image and each learning image other than the reference image included in the learning image group is represented by a distance between a position of the reference image in an image space and a position of each of the learning images in the image space, and each of the learning images is classified into any one of a plurality of distance classes by a distance to the reference image,
the second learning model is a learning model in which learning of the reliability is performed when each of the reference images is given and the reliability for a plurality of distance classes is given as teacher data,
the processing circuitry is further configured to
give the query image to the second learning model and acquire reliability for a plurality of distance classes as the reliability of retrieval when K gallery images having a relatively high possibility of including a subject included in the query image are retrieved from the second learning model, and
acquire reliability of a distance class including K gallery images retrieved from among the acquired reliability of the plurality of distance classes and specifies the reliability of the retrieval from the reliability acquired for the distance classes.

5. An image retrieving method comprising:
giving a query image that is an image to be identified to a first learning model, acquiring a feature vector of the query image from the first learning model, giving each of a plurality of gallery images that are images to be identified to the first learning model, and acquiring a feature vector of each of the gallery images from the first learning model;
giving the query image to a second learning model, and acquiring, from the second learning model, reliability of retrieval when K (K is an integer equal to or more than one) gallery images having a relatively high possibility of including a subject included in the query image are retrieved from the plurality of the gallery images;
retrieving the K gallery images from the plurality of the gallery images on a basis of the feature vector of the acquired query image and the feature vector of each of the gallery images; and
specifying the reliability of retrieval from the acquired reliability.
